(19) United States
(12) Patent Application Publication
(10) Pub. No.: US 2024/0074444 A1
(43) Pub. Date: Mar. 7, 2024

(54) Yeast Cultivation Mixture for Bread Dough

(71) Applicant: Phillip Wells, Knoxville, TN (US)

(72) Inventor: Phillip Wells, Knoxville, TN (US)

(21) Appl. No.: 18/461,975

(22) Filed: Sep. 6, 2023

Related U.S. Application Data
(60) Provisional application No. 63/404,326, filed on Sep. 7, 2022.

(51) Int. Cl. A21D 8/04; A21D 2/16; A21D 2/18; A21D 2/26; A21D 2/36; A21D 8/06; A21D 10/00

(52) U.S. Cl. CPC A21D 8/047; A21D 2/165; A21D 2/181; A21D 2/262; A21D 2/263; A21D 2/36; A21D 8/06; A21D 10/002

(57) ABSTRACT

A method for preparing bread dough includes providing a yeast mixture including active dry yeast, water, and sweetened condensed milk; providing a shortening mixture including vegetable shortening, water, salt, and sugar; heating the shortening mixture, such that substantially most of the vegetable shortening is melted; adding whole milk and room-temperature water to the shortening mixture; adding egg yolk to the shortening mixture; adding flour to the shortening mixture; combining the shortening mixture and the yeast mixture to form a combined mixture; adding flour to the combined mixture; and thoroughly mixing the combined mixture in order to distribute moisture evenly throughout the combined mixture.

### CROSS-REFERENCE TO RELATED APPLICATIONS

This application claims the benefit of the filing date of U.S. Provisional Patent Application Ser. No. 63/404,326, entitled “Yeast Cultivation Mixture for Bread Dough” and filed Sep. 7, 2022, the entire content of which is incorporated herein by reference.

### STATEMENT REGARDING FEDERALLY SPONSORED RESEARCH OR DEVELOPMENT

Not Applicable

### BACKGROUND OF THE INVENTION

The present invention pertains generally to mixtures and methods for baking bread and, more particularly, to cultivating and using yeast in the preparation of bread dough.

### SUMMARY OF THE INVENTION

Disclosed herein are various example embodiments of the present general inventive concept.

Thus, in some example embodiments of the present general inventive concept, a method of preparing bread dough comprises providing a yeast mixture including active dry yeast, water, and sweetened condensed milk; providing a shortening mixture including vegetable shortening, water, salt, and sugar; heating the shortening mixture, such that substantially most of the vegetable shortening is melted; adding whole milk and room-temperature water to the shortening mixture; adding egg yolk to the shortening mixture; adding flour to the shortening mixture; combining the shortening mixture and the yeast mixture to form a combined mixture; adding flour to the combined mixture; and thoroughly mixing the combined mixture in order to distribute moisture evenly throughout the combined mixture.

Some embodiments of the present general inventive concept further include, after adding flour to the combined mixture, covering the combined mixture and leaving the combined mixture at rest at room temperature for a predetermined period of time. In some embodiments, the pre-determined period of time is from nine to eleven minutes. In some embodiments, the pre-determined period of time is approximately ten minutes.

In some embodiments, the step of mixing the combined mixture in order to distribute moisture evenly throughout the combined mixture includes flipping the combined mixture.

In other aspects of the present general inventive concept, a method of preparing round dinner rolls includes preparing a dough by combining a yeast mixture and a shortening mixture; dividing the dough into approximately twelve (12) dough balls, each approximately 2.0 ounces in weight, well rounded, and pinched on one (bottom) side; positioning the dough balls on a pan with the pinched side down, with approximately equal spacing between adjacent dough balls; positioning the pan with dough balls on a warm surface for a pre-determined length of time from 90 to 120 minutes such that the dough rises; and baking the dough balls in an oven at 425° F. for eight (8) minutes.

### FIGURES

The above-mentioned and additional features of the invention will become more clearly understood from the following detailed description of the invention read together with the drawings in which:

FIG. 1 is a flow diagram illustrating a method or process for preparing bread according to one example embodiment of the present general inventive concept.

### DETAILED DESCRIPTION

Various example embodiments of the present general inventive concept will now be described. However, it should be understood that numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Thus, by way of example, according to one example embodiment of the present general inventive concept, sweetened condensed milk (4 ounces) and water (1 ounce) are combined and stirred until thoroughly mixed; then, active dry yeast (6 teaspoons/1.0 ounce) is added to the mixture of sweetened condensed milk and water, and the mixture is stirred until thoroughly mixed. Thereafter, the vessel containing the mixture of yeast, condensed milk, and water is covered and placed in refrigeration for approximately 25 minutes.

In a separate vessel, vegetable shortening (6 Tablespoons/3.0 ounces), water (½ cup), salt (1 teaspoon), and sugar (3 Tablespoons) are mixed in a small saucepan and heated until the mixture is warm, with the water at least steaming, the sugar substantially fully dissolved in the water, and substantially most of the vegetable shortening melted (but not itself boiling). After being warmed to that condition, the shortening mixture is allowed to cool. Then, whole milk (½ cup/4 ounces) and room-temperature water (approx. 7 ounces) are added to the shortening mixture. The shortening mixture is allowed to reach approximately room temperature, and then one (1) egg yolk is added to the shortening mixture. (Preferably, the egg yolk is from a jumbo sized egg.) Next, flour (15 ounces) is added to the shortening mixture, and the mixture is thoroughly mixed.

In the next step, the shortening mixture is combined with the mixture of yeast, condensed milk, and water, and the whole mixture (now dough) is thoroughly mixed. Additional flour (15 ounces) is added to the mixture (dough), and the whole mixture is thoroughly mixed (preferably using a mixer with a dough hook) to distribute moisture throughout the dough. The dough is covered and allowed to rest at approximately room temperature for approximately ten (10) minutes, thereby allowing time for the flour in the dough to hydrate. Then, the dough is uncovered, generally mixed again, and if necessary flipped and/or otherwise manipulated to distribute moisture that may have collected at the base of the dough or in some other portion of the dough. At this point in time, the dough is ready for use in baking.

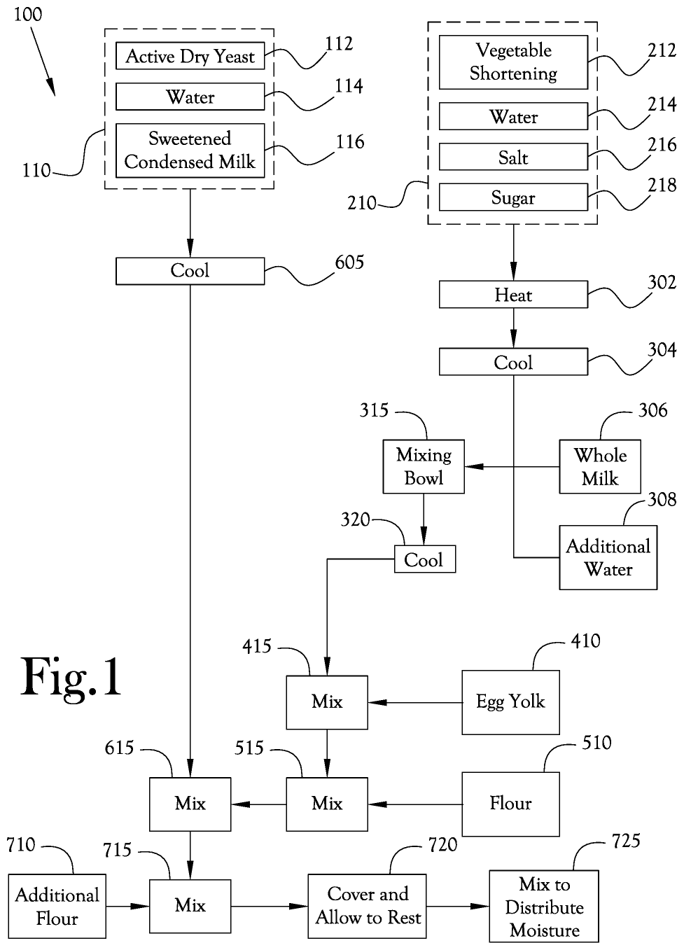

Turning to the FIGURE, FIG. 1 shows a flow diagram of a method for preparing bread dough according to one example embodiment of the present general inventive concept. As shown in FIG. 1, a process 100 for preparing dough involves a yeast mixture 110 that includes active dry yeast 112, water 114, and sweetened condensed milk 116. Separately, a shortening mixture 210 is provided, which includes vegetable shortening 212, water 214, salt 216, and sugar 218. The vegetable shortening 212, water 214, salt 216, and sugar 218 are mixed in a small saucepan and heated 302 until the mixture is warm, with the water at least steaming, the sugar substantially fully dissolved in the water, and substantially most of the vegetable shortening melted (but not itself boiling). After being warmed to that condition, the shortening mixture is allowed to cool 304. Whole milk 306 and room-temperature water 308 are added to the shortening mixture in a mixing bowl 315. The shortening mixture is allowed to cool to reach approximately room temperature 320, and then one (1) egg yolk 410 is added to the shortening mixture 415. Next, flour 510 is added to the shortening mixture 515, and the shortening mixture is thoroughly mixed.

The yeast mixture is covered and placed in refrigeration and cooled 605 before being combined with the shortening mixture to form a combined mixture 615. Then, additional flour 710 is added to the combined mixture 715, which now contains both the components of the yeast mixture and the components of the shortening mixture. The combined mixture is covered and allowed to rest 720 for a pre-determined period of time, and afterwards the combined mixture is thoroughly mixed 725 in order to distribute moisture evenly throughout the combined mixture. If necessary, the combined mixture (now dough) is flipped and/or otherwise manipulated to distribute moisture that may have collected at the base of the dough or in some other portion of the dough. At this point in time, the dough is ready for use in baking.

Another aspect of the present general inventive concept encompasses a method of preparing round dinner rolls. The method involves first placing parchment paper in the bottom of a baking pan. (In this example embodiment, the pan is a 12 inch×18 inch aluminum baking pan.) A dough is prepared from the combination of the yeast mixture and shortening mixture as outlined above. The dough is divided into approximately twelve (12) dough balls, each approximately 2.0 ounces in weight, well rounded, and pinched on one (bottom) side. The dough balls are positioned on the pan with the pinched side down, with approximately equal spacing between adjacent dough balls. The pan with dough balls is placed on a warm surface for a pre-determined length of time (generally from 90 to 120 minutes) in order to allow the dough to rise. The dough balls are then baked in an oven at 425° F. for eight (8) minutes. Once removed from the oven, the rolls are ready to serve. (If reheating is later necessary, baking at 400° F. for five [5] minutes is generally effective and sufficient.)

Various example embodiments of the present general inventive concept provide a method for preparing bread dough, which comprises providing a yeast mixture including active dry yeast, water, and sweetened condensed milk; providing a shortening mixture including vegetable shortening, water, salt, and sugar; heating the shortening mixture, such that substantially most of the vegetable shortening is melted; adding whole milk and room-temperature water to the shortening mixture; adding egg yolk to the shortening mixture; adding flour to the shortening mixture; combining the shortening mixture and the yeast mixture to form a combined mixture; adding flour to the combined mixture; and thoroughly mixing the combined mixture in order to distribute moisture evenly throughout the combined mixture.

Numerous variations, modification, and additional embodiments are possible, and, accordingly, all such variations, modifications, and embodiments are to be regarded as being within the spirit and scope of the present general inventive concept.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of preparing bread dough, comprising:
providing a yeast mixture including active dry yeast, water, and sweetened condensed milk;
providing a shortening mixture including vegetable shortening, water, salt, and sugar;
heating the shortening mixture, such that substantially most of the vegetable shortening is melted;
adding whole milk and room-temperature water to the shortening mixture;
adding egg yolk to the shortening mixture;
adding flour to the shortening mixture;
combining the shortening mixture and the yeast mixture to form a combined mixture;
adding flour to the combined mixture; and
mixing the combined mixture in order to distribute moisture evenly throughout the combined mixture.

2. The method of preparing bread dough of claim 1, further comprising, after adding flour to the combined mixture, covering the combined mixture and leaving the combined mixture at rest at room temperature for a predetermined period of time.

3. The method of preparing bread dough of claim 2, wherein the pre-determined period of time is from nine to eleven minutes.

4. The method of preparing bread dough of claim 2, wherein the pre-determined period of time is approximately ten minutes.

5. The method of preparing bread dough of claim 1, wherein the step of mixing the combined mixture in order to distribute moisture evenly throughout the combined mixture includes flipping the combined mixture.

6. A method of preparing round dinner rolls, comprising:
preparing a dough by combining a yeast mixture and a shortening mixture;
dividing the dough into approximately twelve (12) dough balls, each approximately 2.0 ounces in weight, well rounded, and pinched on one (bottom) side;
positioning the dough balls on a pan with the pinched side down, with approximately equal spacing between adjacent dough balls;
positioning the pan with dough balls on a warm surface for a pre-determined length of time from 90 to 120 minutes such that the dough rises; and
baking the dough balls in an oven at 425° F. for eight (8) minutes.
